(19) United States
(12) Patent Application Publication
(10) Pub. No.: US 2002/0007351 A1
(43) Pub. Date: Jan. 17, 2002

(54) Digital tokens and system and method relating to digital tokens

(76) Inventors: James C. Hillegass, Woodland, MN (US); Yaobing Deng, Minneapolis, MN (US); Mark Eastom, New Brighton, MN (US); Richard R. Fritz, Maple Grove, MN (US); John C. Gateley, Plymouth, MN (US); James A. Grinsfelder, St. Paul, MN (US); Stephen A. Grove, Minneapolis, MN (US); Eric Steven Hockett, Minneapolis, MN (US); Nikolay G. Sokratov, St. Louis Park, MN (US); James G. Swanson, St. Paul, MN (US); John S. Thompson, Afton, MN (US); Boris Mamedov, Hopkins, MN (US); James A. Nordgaard, St. Louis Park, MN (US); Paul E. Onnen, Issaquah, WA (US)

Correspondence Address: Beck & Tysver, P.L.L.C., Suite 100, 2900 Thomas Avenue South, Minneapolis, MN, 55416, US

(21) Appl. No.: 09/845,040

(22) Filed: Apr. 27, 2001

Related U.S. Application Data
(60) Provisional application No. 60/200,229, filed on Apr. 28, 2000.
(60) Provisional application No. 60/200,193, filed on Apr. 28, 2000.

(51) Int. Cl. G06F 17/60; H04K 1/00; H04L 9/00

(52) U.S. Cl. 705/59; 705/58; 705/39

(57) ABSTRACT

A system and method provide digital tokens for use in e-commerce. The tokens are transferable and can be purchased for another person to spend. Such tokens are of particular use in a system and method to distribute licenses for copyrighted material separate from the copyrighted material itself.

This application claims priority under 35 U.S.C. §119(e) to U.S. Ser. No. 60/200,229, filed Apr. 28, 2000 and to U.S. Ser. No. 60/200,193 filed Apr. 28, 2000.

### FIELD OF THE INVENTION

The present invention relates generally to a system and method for converting a credit card payment into a digital token for later use in purchasing goods over the Internet. More particularly, the present invention relates to a system and method of using digital tokens in a system and method for distributing copyrighted materials in digital form and for distributing licenses for the copyrighted materials.

### BACKGROUND OF THE INVENTION

Digital commerce or e-commerce is typically conducted through credit card transactions. This process can be time consuming because every credit card transaction must be approved through the credit card processor before a sale is completed. Further, those without credit cards are unable to make purchases. Still further, for small purchases, the transaction costs can be disproportionately high for the merchant and consumers tend not to appreciate having a long list of small transactions on credit card statements.

Various types of pre-pay systems exist, such as pre-paid phone card, pre-paid store cards, and gift certificates. These systems offer the advantage of requiring a single purchase transaction for one sum after which time the card can be used one or more purchases. Such cards, however, offer no protection against theft: anyone who gets possession of the card or the card number can use it to make purchases.

A method and apparatus for issuing and managing gift certificates is described in U.S. Pat. No. 6,193,155 B1 to Walker et al. In Walker's method, a customer provides a gift certificate including a certificate identifier corresponding to an account identifier at the point of purchase. The merchant, via a terminal, transmits to a central server a request for authorization, with the request including the certificate identifier. The central server determines an account identifier based on the certificate identifier and accesses stored account data associated with the account identifier. The Walker method is apparently initiated with a paper gift certificate that bears the certificate identifier. In a security code embodiment of the system, a credit card issuer distributes a gift certificate and a security code to the recipient. When the recipient uses the certificate, the recipient provides the security code and the merchant transmits the password along with the certificate identifier to obtain authorization to accept the certificate. In Walker's method, use of the certificate requires an interaction with the credit card issuer to approve the use of the certificate and the associated charge to the giver's credit card account. Further, the Walker method requires that the recipient/user keep track of the certificate itself or at least its number to be able to redeem it.

There is a need for an alternative to a typical credit card transaction for e-commerce, particularly for industries that sell low-priced products. The music industry is one such industry. A significant proportion of consumers of music are too young to have credit cards. Further, music products are relatively cheap, with a CD costing typically less than $20. The movie/video industry is another industry which would benefit from the proposed alternative transaction system. Methods are springing forth for digitally distributing music, video and other types of copyrightable material. As systems are developed for distributing such materials (and in particular for distributing these materials with proper copyright licenses), there is a need for developing streamlined, easy-to-use methods of payment operating in conjunction with digital or on-line distribution and licensing systems.

Therefore, authors and producers of copyrightable materials seek secure ways of distributing copyrightable materials in electronic form to purchasers of the materials, and allowing these bona fide purchasers convenient access to the purchased materials, while at the same time preventing subsequent unauthorized copying. Further, it would be advantageous for authorized digital materials to be portable from one computer to another for the authorized purchaser. Thus, it would be advantageous to have alternatives to the typical credit card transaction for distributing digital materials. In particular, what is needed is a system and method for distributing digital gift certificates or tokens that allows redemption of the certificate without requiring the authorization of a credit card company at the time of purchase by the certificate user, thereby speeding the redemption process and limiting network traffic. Further, it would be advantageous for the system to offer protection against unauthorized use of tokens and gift certificates.

### SUMMARY OF THE INVENTION

An alternative payment system and method are disclosed whereby digital tokens are purchased and can thereafter be spent in lieu of a credit card transaction. Such tokens can be purchased for another party (i.e. as a digital gift certificate) or for oneself. The system is advantageous for purchasers because it requires less time to conduct a purchase with a token than with a credit card transaction since the credit card does not have to be cleared and processed when an item is purchased. The system is advantageous for merchants since it reduces the costs of credit card transactions, because purchasers will have fewer transactions each for a greater amount of money than would typically be the case for individual transactions. This reduces the fees that must be paid to credit card companies in transaction fees. Further, the system is advantageous to the networked community as a whole because it reduces network traffic. Still, further, the system is advantageous because it allows a person without a credit card to make purchases. The system is particularly suited for on-line purchase applications in which a product or service is delivered to the purchaser's computer via a networked data connection.

The token is purchased from a token distributor via a typical credit card transaction. The distributor stores a token identifier in association with the user's identifier and a balance. The distributor transmits, such as by email or other means of transmitting data, the token to the user who, using specialized software, installs the token on his/her computer. The installation involves the storage on or in the User's computer of the token identifier in association with the User identifier.

As noted above, such a payment system would be particularly advantageous in the music and video distribution industry. A payment method and system are described in conjunction with a secure and convenient method of distributing music files via a networked data connection, where a producer of the music can distribute files to potential customers, but does not have to attend to licensing and selling functions. Further, to protect the artists' interests, there has been a need to distribute music files such that the music is secure and cannot be easily copied.

An exemplary version of the digital token method and system is described in conjunction with a system and method allow a user to download copyrighted material from any of a number of sources of copyrighted works, and to then purchase licenses to use the material from a License Provider. Because Vendors can store their Products on their own servers, they have complete control over the content of a Product and can change content with minimal difficulty. Further, Products can be offered for download from a variety of places that may be convenient for Users. For example, a Vendor may make the soundtrack of a movie available from the movie's website. Additionally, the Vendor can make the same soundtrack available in a website music store. Finally, a file that has been downloaded and licensed by one User can be shared with then licensed by a second User since files are not changed after licensing to one User.

While Products are available at multiple sites, Users have a convenient single source for licenses, the License Provider.

The system and method further provide security for artists and producers against unauthorized copying. A software component running on User's computers checks to make sure that the appropriate Product License has been purchased and that that Product License is for the computer on which the Product is stored.

Licenses can be purchased with a credit card or through the use of digital tokens.

### BRIEF DESCRIPTION OF THE DRAWINGS

An exemplary version of a system and method for distributing and licensing copyrighted materials is shown in the figures wherein like reference numerals refer to equivalent structure throughout, and wherein:

FIG. 1 is a schematic illustration of the process of purchasing tokens and gift certificates;

FIG. 2 is a flow chart illustrating the process of facilitating the redemption of a token;

FIG. 3 is a token table identifying data stored in a database in the preferred system and method of the present invention;

FIG. 4 is a token transactions table identifying data stored in a database in the preferred system and method of the present invention;

FIG. 5 is a token transaction type table identifying types of transactions involving tokens; the token transaction type table is stored in a database in one embodiment of a system and method of the present invention.

FIG. 6 is a schematic illustration of the system and method of the present invention;

FIG. 7 is a flow chart describing the process for creating a Product, distributing and licensing the Product, and using a licensed Product;

FIG. 8 is a schematic illustration showing how multiple Vendors and Users are coordinated through the system and method of the present invention;

FIG. 9 is a detailed schematic illustration of the system and method of the present invention;

FIG. 10 is an illustration of a database for use in conjunction with the License Provider's database;

FIG. 11 is a schematic illustration of the security checks made to verify that a Product License authorizes the playing of a given Product, according to the system and method of the present invention; and

FIG. 12 is a schematic illustration of the use of tokens and gift certificates in conjunction with the digital material distribution system illustrated in FIGS. 1-6.

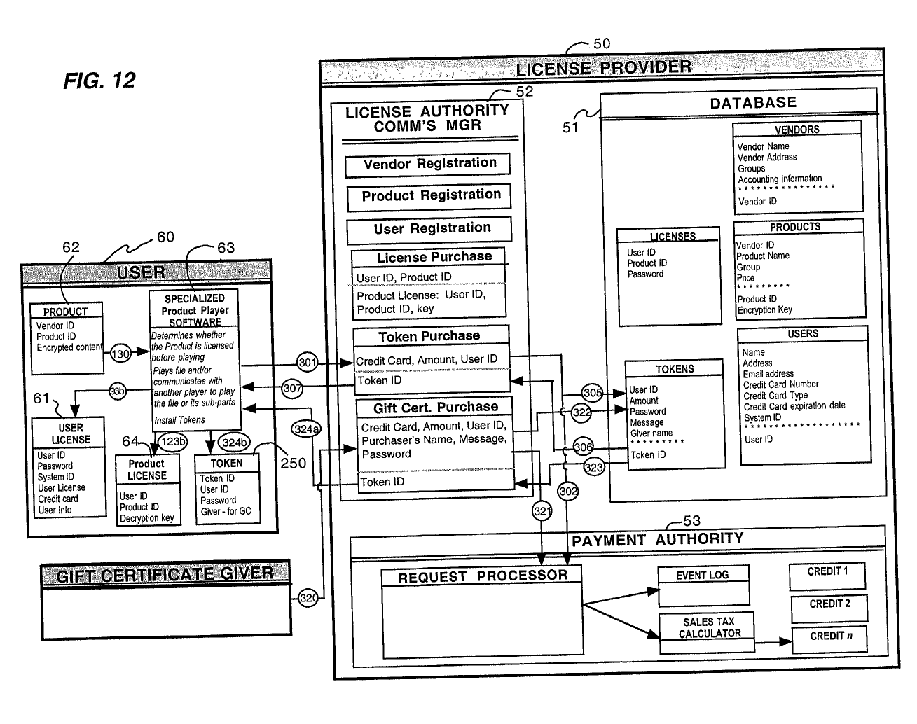

### DETAILED DESCRIPTION OF PREFERRED EMBODIMENT(S)

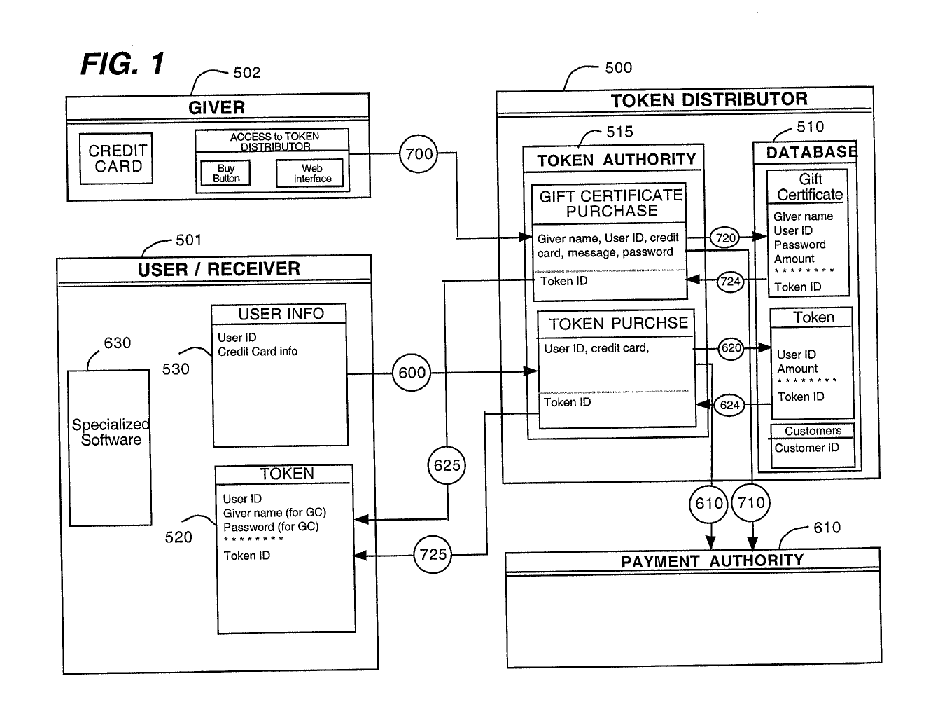

As illustrated in FIG. 1, the system and method of the present invention involve a token distributor 500, a token receiver 501 and a token giver 502. In some cases, the giver will be the same as the receiver 501, and in other instances, they will not be the same. In either event, the token receiver can also be termed the token user. The token distributor 500 and the receiver 501 have software and databases for performing functions in the method and system of the invention. Specifically, the distributor 500 has a database 510 for storing information regarding tokens and token receivers. The distributor 500 has software 515 (“token authority software”) for receiving, processing and sending information regarding tokens and payment for tokens. The receiver 501 has a computing device having storage 520 for tokens and storage 530 for information identifying the receiver. “Computing device” or “computer” is any device that can be networked for data transmission therewith, has storage or can be networked to data storage, and can run software that are now known or are yet to be invented. This includes, but is not limited to, personal computers, personal digital assistants, communication devices, and specialized devices for playing digital files, such as MP3 players.

When someone wishes to purchase a token for their own use, he or she is both the giver and the receiver 501. The receiver 501 sends a request to purchase a token from the token distributor 500 (step 600). The request preferably contains a piece of data that uniquely identifies the receiver (“User ID”). If the receiver has previously “registered” with the token distributor and the token distributor has given the receiver a unique receiver identification number. The request further identifies the amount that the receiver wishes to purchase. The request includes the receiver's credit card information, such as the credit card number, the type of card, the expiration date and the like.

The token authority software 515 passes the credit card information to a credit card processor (“Payment Authority”) 610 for processing. When the transaction has cleared, the token distributor 500 stores the token information in its database 510 (step 620), assigns and stores a unique token identification number and returns the token with its token ID to the receiver 501 where it is stored (624, 625). Thus, the token includes a token identifier and a customer or user identifier. In a system where more than one vendor sells tokens, a vendor identifier may also be included in the token.

The process is similar for a gift certificate. A giver 502 sends a request to the token distributor 500 (700). The request includes the giver's name, the amount requested, the User ID of the receiver, a password, a message, and the giver's credit card information. The token authority software 515 passes the credit card information to the Payment Authority for processing. When the transaction is cleared, information regarding the gift certificate is stored in the database 510 (step 720), a unique token ID is assigned and stored, and the token is forwarded to the designated receiver (724, 725). The gift certificate includes a token identifier, a user identifier, a password, a text message from the giver, and a text identification of the giver.

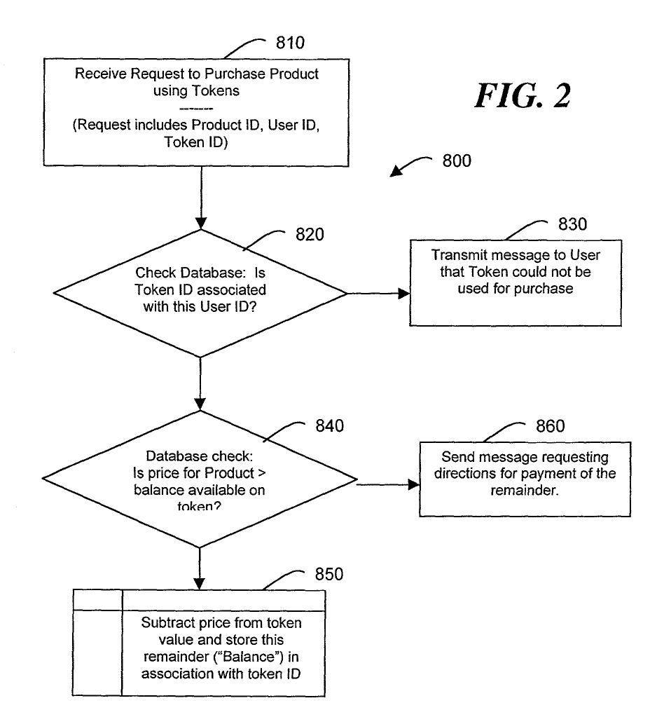

With either a token or gift certificate, the receiver/user 501 uses specialized software to install the otken on the user's computer. Once the token or gift certificate has been installed, a User can use the token to purchase a product or service. FIG. 2 illustrates the redemption process 800 from the perspective of the token distributor/redeemer entity. The token distributor receives a request transmitted by a user to make a purchase with a token (810). This request includes the token identifier and, preferably, the User identifier. The user's specialized software allows the user to simply request to use available tokens, without necessarily requiring the user to type the token identifier. The user's software simply accesses the stored token data and the purchase request then automatically includes the token information. The token distributor runs a couple of checks on the token to determine whether it can be used for the purchase. The distributor interrogates its database to determine whether the token identifier is stored in association with the User ID, as specified in the request (820). If the token identifier and the user identifier do not “match” in this manner, then the distributor transmits a message indicating that the token cannot be used (830). If the token identifier and the user identifier match, then the distributor determines whether the price or amount for the product(s) to be purchased is greater than the value of the user's token (840). If the token is for equal or greater value than the purchase price, then the purchase price is subtracted from the token value and the balance is stored in the database (850).

If the token is not sufficient to cover the cost of the purchase, the distributor transmits a message to the User that the token is insufficient to cover the whole purchase and request further instructions from the User. Alternatively, the user's software or the distributor's token authority may automatically determine whether the user owns other tokens and apply those tokens to the purchase. As another alternative, the distributor may apply the whole token and process payment for the amount not covered by the token via traditional credit card transaction or the like. The distributor transmits to the user's computer an updated balance for the token. Preferably, the user's specialized software includes functions that allow the user to view their tokens and their available balances.

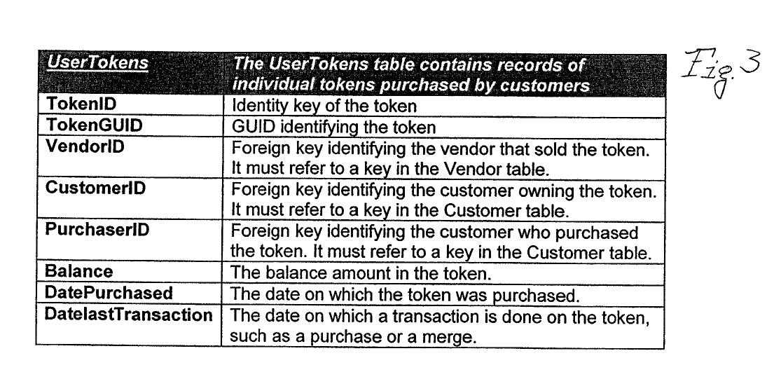

A preferred token table in the token distributor's database 510 is illustrated in FIG. 3. The table contains records of individual tokens purchased by customers. Each record contains fields for the following types of data: the token identifier, the TokenGUID, the vendor identifier (identifying the vendor which sold the token), the customer identifier (identifying the customer owning the token and refering to a key in the Customer table of the database), the purchaser identifier (identifying the person who purchased the token and referring to a key in the Customer table of the database), the balance amount in the token, the data on which the token was purchased, the date of the last transaction involving the token. In an embodiment in which tokens are prescribed to have a limited life, the token table includes a “void after” date.

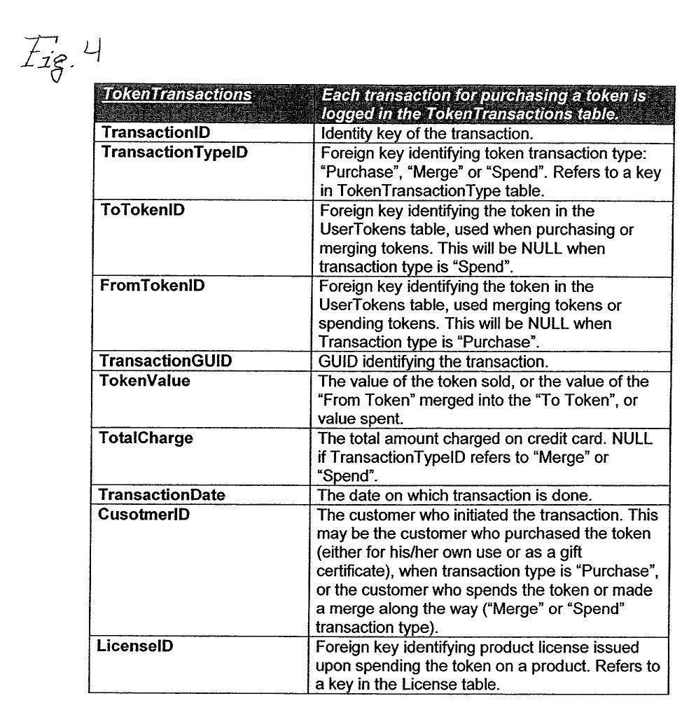

The database 510 preferably includes a token transaction table, as illustrated in FIG. 4. Each transaction for purchasing a token is logged in the token transactions table. For each transaction, the following items are stored: a unique transaction identifier; a transaction type identifier (as will be described in greater detail below); a “To Token” identifier and a “From Token” identifier (one of which is null depending on whether the transaction is for the purchase, spending or merging of a token(s) (as will be described below); a transaction GUID; the “Token Value” which is the value of the transaction; the “Total Charge” or amount charged on a credit card for token purchase transaction or “null” for merge or spend transactions; the transaction date; the customer identifier; and the license identifier for any licensed products purchased with the token, as will be described in greater detail below. The “token value” and the “total charge” may or may not be equal; for example, if a Vendor or the License Provider offers a discount on a Product, the “token value” will be greater than the “total charge”.

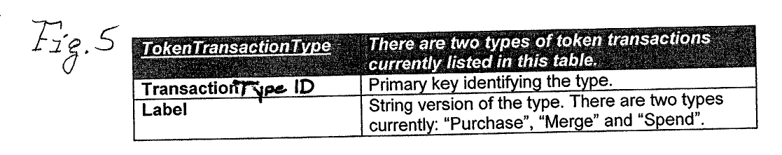

In a preferred embodiment, the database 510 further includes a transaction type table as illustrated in FIG. 5. The transaction type table stores a list of the types of transactions allowed with tokens and each transaction record is stored in association with the following: a unique transaction type identifier and a textual label for the type. In a preferred embodiment, there are three types of transactions: “purchase”, “merge” and “spend”.

The token is emailed or otherwise transmitted digitally to the User's computer and the User's specialized software 630 installs the token in the registry of the User's computer. Until this installation procedure is accomplished, the token is not useable. In other words, knowing the Token ID (which perhaps might be contained in the text of the email message) does not give the User access to the value of the token.

### Preferred Embodiment in Conjunction with Distribution of Copyrighted Materials and Licenses Therefor

Here follows a detailed description of the use of tokens and gift certificates as they would be incorporated into a system for distribution of licensed copyrighted materials in digital form. A system and method for distributing digital licenses is described in U.S. application for patent, U.S. Ser .No. ______ , filed Apr. 27, 2001, entitled Licensed Digital Material Distribution System and Method, by Hillegass et al and is incorporated herein by reference.

As used herein, “copyrighted materials” means any work that is protected by copyright laws of the U.S. or other countries, including without limitation: literary works; musical works, including any accompanying words; dramatic works including any accompanying music; pantomimes and choreographic works; pictorial, graphic, and sculptural works, motion pictures and other audiovisual works; sound recordings; and architectural works.

“Electronic media” means any electronic form on which copyrightable material can be stored in the form of a digital representation, including without limitation: computer memory, CD, CD-Rom, magnetic disk, or digital video disk. “Electronic media” also includes digital files in transit over a computer network, such as a Local Area Network (LAN), Wide Area Network (WAN) or the World Wide Web (“Internet”). It is contemplated that additional kinds of “electronic media” may now exist and may come into existence in the future and will perform the function of storing copyrightable material in the form of a digital representation. For example, some manufacturers, like Sony, are creating device-specific memory cards for storing music files for playback on the devices and such devices are within the definition of “electronic media”.

“Product” means a file, container, object or the like that is stored on or in electronic media that carries one or more pieces of copyrighted material.

“Identifier” means a number, text, characters or any combination thereof, including but not limited to a serialized or unique identification number.

A preferred embodiment of the present invention is used in conjunction with Products that are multi-track, multi-media music files. Such files can include, for each track, the music track itself, liner notes, lyrics, images, and information about the track such as the artist, the year of release and the like. Portions of the detailed description to follow will focus on the use of the invention in conjunction with such multi-track, multi-media music Products, but it is to be understood that the system and method of the present invention are intended to be used in conjunction with any Products regardless of content.

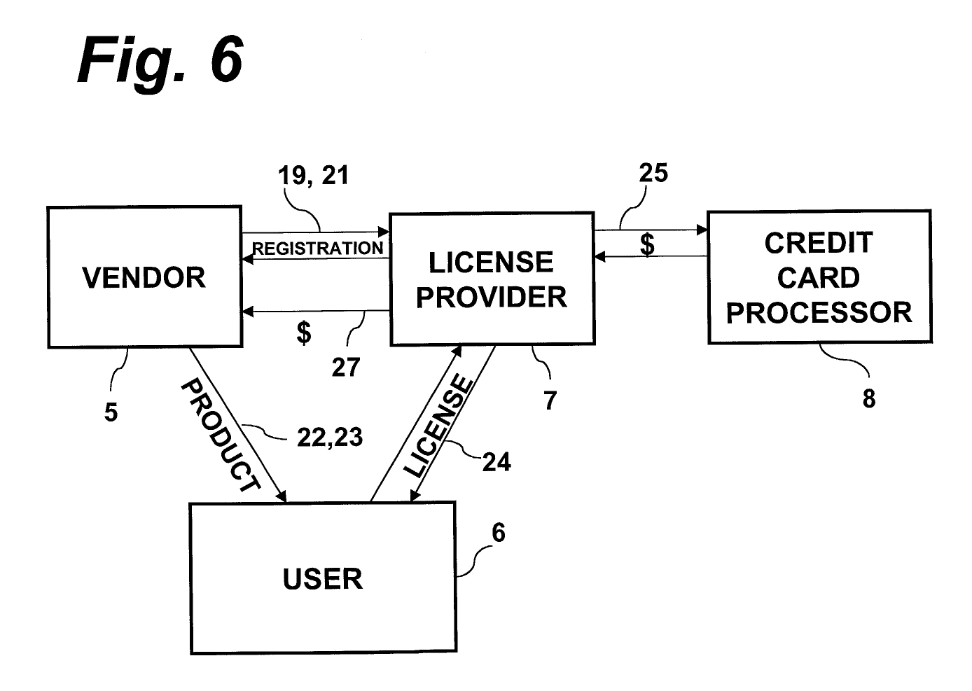

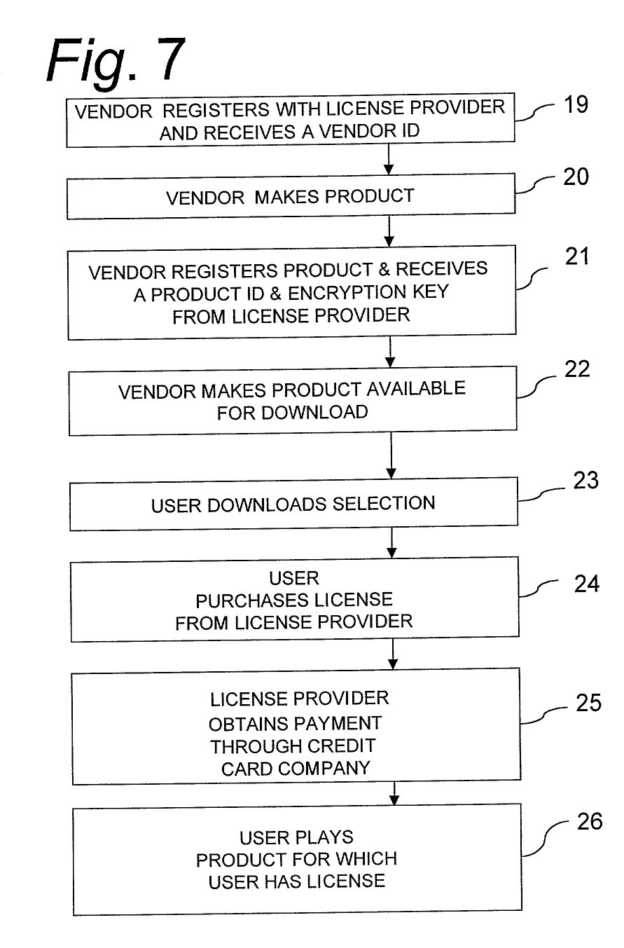

As illustrated in rudimentary form in FIG. 6, a system and method for distributing licensed digital materials coordinates the activities of an author, artist or producer (“Vendor”) 5, an end user (“User”) 6 of the copyrighted materials, a “License Provider” (“License Provider” or “LP”) 7, and an entity for processing credit card transactions (“Credit Card Processor”) 8. The basic steps in a method for distributing licenses for copyrighted material are illustrated in FIGS. 6 and 7. The Vendor registers itself with a License Provider 7 (19). The Vendor 5 then creates a Product 10 (step 20). The Vendor 5 then registers the Product with the License Provider 7 (21). The Vendor 5 makes the Product available to Users 6 on or through Electronic Media, such as via the Internet, ftp, CD, or e-mail (step 22). The User 6 downloads selected Products from the Vendor 5 and is able to view a preview of the contents of the Product (23). If the User 6 wants to view and own the right to use the entire contents, the User 6 then purchases a license from the License Provider 7 for that Product (24). This purchase can be made via a typical credit card transaction in which case the License Provider 7 passes the User's credit card information through a Credit Card Processor 8 or other transaction agent to obtain payment (25). Alternatively, the purchase can be made through the use of a digital token that was previously purchased via a credit card. After the User 6 has purchased a license, the User 6 is able to fully play and view the Product 10 (26). The License Provider 7 pays the Vendor 5 for sales of its registered Products (27).

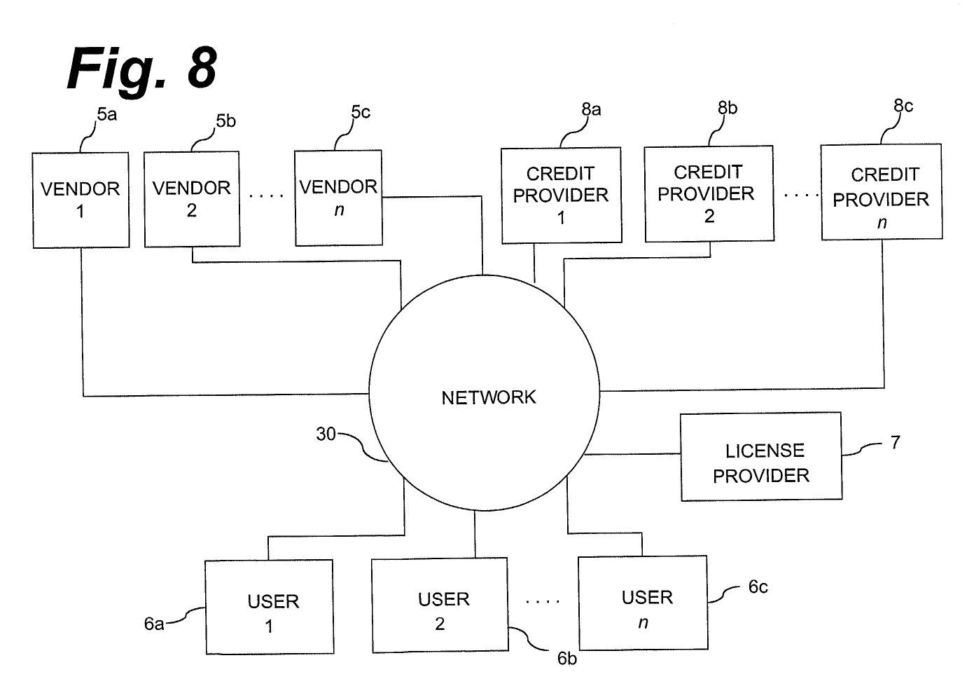

As illustrated in FIG. 8, the system and method of the present invention accommodate multiple Vendors 5a-5c, multiple Users 6a-6c, and multiple Credit Card Processors 8a-c. In a preferred embodiment, the Vendors 5 store Products 10 on servers and make Products 10 available to User 6 over a network 30, such as the Internet, for download onto their personal computer hard drives. The License Provider 7 stores license and Product information, but not necessarily the Products 10 themselves, on a server. The License Provider 7 makes licenses available for Users 6 to purchase over the Internet. The License Provider 7 is networked, either through a dedicated connection or through the Internet to Credit Card Processors 8.

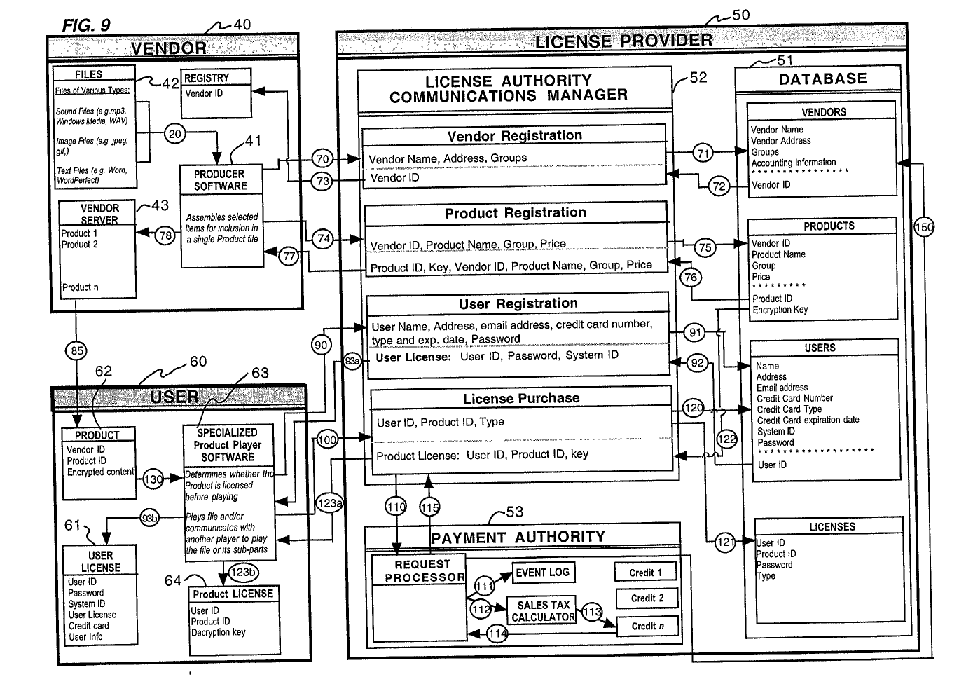

The Users 6, Vendors 5, and License Provider 7 use a combination of hardware, software and databases to accomplish functions in the system and method of the preferred embodiment of the present invention. As illustrated in FIG. 9, the Vendor's component 40 includes software 41 for producing Products (“Producer Software”), file storage space 42 for the files that are used to make Products 10 and a server 43 with file storage space for storing Products 10 and through which Products 10 are made available for download. In the illustration, Products 10 are shown being hosted for download on the Vendor's server 43. However, the Vendor alternatively, or in addition, can make Products 10 available on web sites hosted by others.

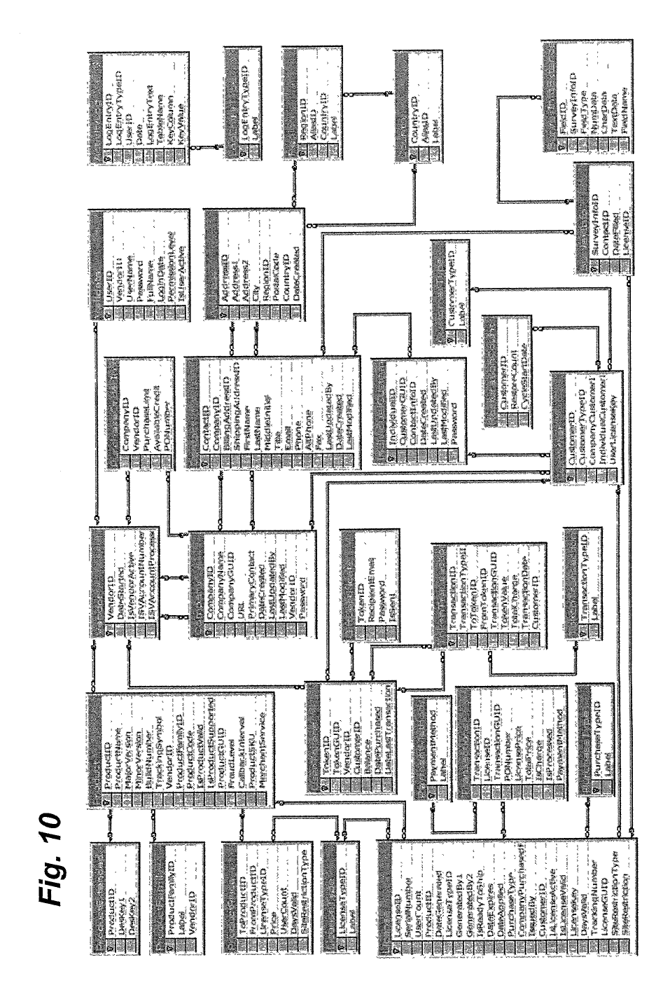

In the preferred embodiment illustrated, the License Provider's component 50 includes generally three sub-components: a Database 51, a License Authority Communication Manager 52 (“License Authority” or “LA”), and a Payment Authority (“PA”) 53. The Database 51 stores data regarding registered Vendors 5, registered Products 10, licensed Users 6, Licenses, and various other administrative information such as license revenue and other accounting functions related to the Licenses. FIG. 10 shows a more detailed list of the types of data that Database 51 preferably contains.

License Authority 52 is the command and control center of the License Provider 7. It manages communications between Vendor components 40 and the License Provider's backend servers (Database 51 and Payment Authority 53). The License Authority 52 accepts service requests from the Vendor components 40 to register Vendors and to register Products. The License Authority 52 also manages communications between User components 60 and the License Provider's backend servers (Database 51 and Payment Authority 53). It accepts service requests from the User component 60 for purchasing of Licenses; processes credit card transactions through the Payment Authority 53; and creates licenses and saves them in the Database 51. Payment Authority 53 handles credit card authorization and charges.

The User's component 60 includes storage space for their system identification information and for their User License (e.g. their computer's registry) 61, storage space 62 for Product files 10, specialized software 63 for playing and viewing Products 10 and managing licenses and storage space 64 for Licenses. The software 63 may include more than one program. For music Products 10, music players such as Winamp and Windows Media Player can be used for playing files. To use such programs in conjunction with the present invention, a plug-in is provided to handle licensing and decryption. Alternatively, the licensing software may include a player software. Similarly, the license management software may stand alone and work in conjunction with the player or it may be part of the same software. In one preferred embodiment of the User's component 60, several software products available through J. River are employed. For example, Media Jukebox™ organizes and plays digital music, License Manager™ keeps track of a User's digital licenses and allows backup and restoration of licenses, and a Buy Button™ component provides for expeditious purchasing of Licenses. Buy Button preferably communicates directly through Remote Procedure Calls (RPC) to the License Authority 52 of the License Provider component 50 to make purchases and, upon completion of a purchase, saves a license on the User's component 60.

In a preferred embodiment, the Vendor, User, and License Provider components 40, 50, 60 are connected to one another for data transmission via a computer network, such as the Internet. In a preferred embodiment, the License Provider communicates directly through Remote Procedure Calls (RPC) with the Vendors 5 and the Users 6. In alternative embodiments, the License Provider's component 50 and the Vendor's component 40 may include web servers for hosting web sites to facilitate communication. For example, the Vendor's web site may include pages advertising Products 10 for Users' selective download. The License Provider's site would have pages or screens for soliciting information about the User 6 (e.g. name, address, credit card) and for returning Licenses to the User 6.

The steps 19-27 involved in a preferred method and system of the present invention are now described in greater detail, with reference to FIG. 9.

Vendor Registration (Step 19)

The Vendor 5 must first become a registered Vendor. Specialized producer software 41 facilitates this process. Specialized software 41 communicates via remote procedure calls (“RPC”) with the License Provider's component 50. The Vendor 5 is asked to provide its contact information (e.g. name, address, phone number, as well as accounting information to facilitate later payment by License Provider 7 to Vendor 5 for licenses sold for Vendor's Product) (step 70). The License Provider 7 stores this information in its database (71), assigns and stores a unique Vendor identification number (“Vendor ID”)(72), and returns the Vendor ID to the Vendor 5 (72, 73). The Vendor ID is stored in the Vendor's computer and is automatically accessed by the producer software 41 each time the Vendor 5 seeks to register a Product 10.

Product Creation (Step 20)

In a preferred embodiment, the Vendor 5 uses specialized software 41 to create a Product 10 for distribution and licensing through the system and method of the present invention. The producer software converts digital audio and supporting multi-media elements into a Product 10. There are three steps in this process: compression, collection, and file creation/registration. The first step is the conversion of either traditional digital audio (CDs) or uncompressed Windows Audio Format (.wav) files into a compressed format.

The second step is the collection of supporting information to be added to the compressed audio file. Such supporting information may include text such as lyrics or liner notes, graphics and video content. Security features such as watermarking technology can be incorporated to add another level of protection to the file.

The final step is the compilation of audio, text, and graphics files into a single file, i.e. a Product (step 20).

The present invention producer software 41 allows the Vendor 5 to rip, encode, encrypt and compile tracks accompanied by images, text and URL's. To begin using the producer software 41, the Vendor 5 inserts a CD into the computer's CD drive or otherwise loads or selects items to be included in the completed Product. Preferably, a Project Wizard guides the Vendor 5 through all the steps in creating a Product file. If the Vendor 5 needs to rip and encode tracks from a CD, he/she can choose “Create New Project From CD” in the first step of the Project Wizard. If, on the other hand, the Vendor 5 does not need to rip and encode tracks from a CD, and just wants to create a Product 10 with existing digital files, the Vendor 5 will choose “Create new Media Project” instead. The software 41 displays a list of tracks contained on the CD. If the tracks on the CD are included in the publicly available cddb database (www.cddb.com), their titles will appear. These tracks can then be selected and deselected, depending upon which ones the Vendor 5 wants to include in the Product 10. Next the Vendor 5 selects the quality and format of the tracks that are being ripped and encoded. The Vendor 5 is asked to choose a preferred compression and bitrate. Any of the listed compression types can be stored within the single Product. After the tracks are copied, a Track Layout window appears. If the Vendor 5 wants to add other files to ones that have just been copied, he/she can simply drag and drop them into the window or use the “Add File” and “Delete File” functions to organize tracks. Once the desired tracks are organized, the Vendor 5 can add text notes describing the CD or individual track notes and lyrics. CD and individual track Images can also be added simply by drag and drop, or if necessary, by using the built-in scan functionality. Imported bmp or tif images are automatically converted to jpg.

Once the Vendor 5 has compiled the applicable tracks, text and images, he/she will need to “Compile Virtual CD.” This takes the files just created and transforms them into a Product. When the Vendor 5 chooses to “Compile Virtual CD”, the program guides him/her through several steps. Before any steps are taken, however, the program checks the Vendor's registry to find out whether the Vendor 5 has already registered himself/herself with the License Provider 7. If the Vendor 5 is not a registered vendor, then the product being created cannot be registered with the License Provider 7 and steps to register the Product 10 with the License Provider 7 are skipped. The Product 10 can be compiled into an unregistered/unprotected file. If the software determines that the Vendor 5 has been registered with the License Provider 7, then the Vendor 5 will be presented with an option (such as with a check box) to register the Product 10.

Product Registration (Step 21)

After all needed information that is to be built into the Product is collected, the Vendor 5 registers the Product with the License Provider 7. The Product Registration process (21) does not require or provide for the Vendor 5 to send the Product file itself to the License Provider 7. Rather, the Vendor 5 merely sends information regarding the Product 10 and the Vendor 5 to the License Provider 7, and the License Provider 7 returns information that is added to the Product file 10 using the specialized producer software 41. In a preferred embodiment, information is passed between the Vendor 5 and the License Provider 7 by Remote Procedure Calls (RPC) from the Producer software 41 and License Authority 52.

More specifically, when a Vendor 5 seeks to register a Product 10, the Vendor 5 checks the “Create Registered Virtual CD” check box when doing “Compile Virtual CD”. This is possible only if a Vendor ID is found in the Vendor's registry, indicating that the Vendor 5 is a registered vendor. The program sends this Vendor ID to the License Provider, along with information on the Product 10 being registered. The License Provider 7 searches its database 51 of Vendors 5 to determine whether the Vendor ID presented is a valid ID. If the Vendor 5 is not registered, the producer software 41 will either not find a vendor ID in the Vendor's registry, or an invalid Vendor ID may be found. In the former case, the producer software 41 will not try to register the Product 10 with the License Provider 7. In the latter case the producer software 41 will try to register the product, but the registration will fail. The Vendor 5 can select “Register Vendor” within the producer software 41 to register himself/herself/itself with the License Provider 7. The Vendor 5 is asked to provide its contact information (e.g. name, address, phone number, as well as accounting information to facilitate later payment by License Provider 7 to Vendor 5 for licenses sold for Vendor's Product) (step 70). The License Provider 7 stores this information in its database 51 (71), assigns and stores a unique Vendor identification number (“Vendor ID”)(72), and returns the Vendor ID to the Vendor 5. The Vendor ID is stored in the Vendor's computer (73) and is automatically accessed by the producer software 41 each time the Vendor 5 seeks to register a Product 10 subsequently.

For subsequent Product registrations, when the Vendor 5 selects “Product Registration”, the Vendor's computer will automatically access the Vendor ID from the computer's registry and will send the Vendor ID with the submission. The License Provider 7 will read the Vendor ID, find it in its database 51 and then register the Product. The Vendor 5 is asked to enter a Product name, the price of the Product and a “group” (74) from a predefined list of groups. In a preferred embodiment, the Vendor 5 is allowed to define their own groups, where a group will typically be a type of music or other such classification. The Product name must be unique within the group. The License Provider 7 stores this Product information in its Database 51 (step 75). The License Provider 7 assigns a unique Product identification number (“Product ID”) and an encryption key (76) and returns this to the Vendor 5 (77). The Product ID and encryption key are added to the Product file by the producer software (78).

In alternative embodiments, the order of steps 19-21 can be modified and software 41 can be adapted according to the preferred order or to accommodate a variety of orders. In any event, to generate a Product 10 that is ready for distribution, the Vendor 5 registers itself (19) and its Product 10 (21) with the License Provider 50 and compiles a Product file 10 that incorporates the selected content and an encryption key and Product ID into its Product file (20).

Product Distribution (Step 22)

Once this file is assembled with the Product ID and encryption key, the Vendor 5 can distribute the Product, with its Product ID attached, on CD, in an ftp server, via e-mail, by making it available for download from one or more locations on the world wide web, or using any other electronic media (85).

The Product includes a preview that is accessible to a prospective User 6 without purchasing a License to the full content of the Product.

License Purchase (Steps 24 and 25) via a Typical Credit Card Transaction

When a customer decides to purchase the right to enjoy the full capabilities of a Product, the User 6 must purchase a License from the License Provider 7. This process is initiated in software running on the User's component 60 and through a data transfer connection to the License Provider 7, such as through an Internet connection.

In a preferred embodiment, the specialized software 63 calls the License Authority 52 on the License Provider's server via RPC calls. The User 6 is asked to provide identifying information including their name, address, email address and credit card number, type and expiration date (90). The first time a User 6 purchases a product, the License Provider 7 stores the information in its database 51 (91) with an assigned unique user identification number (“User ID”). The User License is returned to the User's computer (92, 93a, 93b). The User License contains the unique User ID and the User's personal data. A User License is saved or updated in the registry of the User's computer in encrypted form. This User License is created only once for a given User 6 but is updated every time the User 6 makes a purchase. The User 6 can back up the User License, which can then be restored in case of a hard disk failure. A backed-up User License can also be restored to a different machine so the same User 6 will not have multiple User Licenses when using multiple computers. The personal information is locked by the User's password.

The second and subsequent times that a User 6 seeks to purchase a license, the User's name, address, credit card information will be shown to the User 6, after the password is entered and the User 6 can modify it if desired.

Once the User 6 is registered, the User 6 can send to the License Provider 7 a request to purchase a specified Product 10 (100). The License Authority 52 processes the purchase information received, i.e. the User ID, credit card information and Product ID. It first does a rudimentary check to make sure that the credit card number has the appropriate number of digits, that the state in the address is recognizable and that the first line of the address is present. If the User's information passes this check, the credit card information coupled with the Product information, including Product ID, Product Name and price, are forwarded to the Payment Authority residing on the License Provider's server (110). The Payment Authority then logs the transaction (111), calculates sales tax (112), and routes the information to a credit card merchant or other transaction processor for processing (113). When the charge is approved (114, 115), the License Provider's server creates or updates (depending on whether the User 6 is making a purchase for the first time) entries in the database of the User's personal information (120) and then creates a Product License, saves it in the database 51 (121), and sends a copy back to the User 6 (122, 123a, 123b). The Product License includes the Product ID, the User ID, the Product name and the Vendor 5 name. The Product License is written to the registry of the User's computer in encrypted form.

License Purchase via Digital Tokens

As illustrated in FIG. 8, digital user tokens and gift certificates offer an alternative payment method and system to the credit card transaction described in the foregoing section.

A digital token is purchased via a typical credit card transaction. Specifically, a token is purchased through the specialized software 63. The User submits their User ID and their credit card information and specifies a dollar amount to purchase (301). Software 63 sends all needed data to the License Authority 52 for processing with all sensitive data being encrypted. The License Authority 52 passes the credit card transaction information to the Payment Authority 53 for processing (302). Upon successful purchase, a digital token is generated by the License Authority and stored in the database 51 (305). The token is assigned a unique identification number (“token ID”) that is saved in the database 51 and returned to the User's component 60 (306, 307).

A User may buy tokens for him or herself. A digital “gift certificate” is a way of purchasing tokens for someone else. A gift certificate is purchased via a web browser. The purchaser connects to the License Provider's server by https protocol (for secure connection). Alternatively, where the purchaser is already a User, the purchaser can buy gift certificates using their “Buy Button”. The purchaser gives their name, the name and email address of the recipient/User, a message, a password, a dollar amount to purchase and credit card information (320). The License Authority 52 processes the transaction through the Payment Authority 53 (321) and generates a digital token for the User. The token is stored in the database 51 (322). The database 51 assigns a unique Token ID. The gift certificate is then forwarded, such as by email, to the recipient/User (323, 324). The recipient/User of the gift certificate uses the specialized software 63 to install the received certificate into the registry 61 of his or her computer.

To use the tokens to purchase a Product, the User activates an option in the specialized software 63 for spending the tokens. The software 63 checks with the License Provider's component 50 for the amount remaining in the User's tokens. If the amount of tokens is not enough to cover the cost of the product being purchased, the User can purchase additional tokens using a credit card. If the User has enough token value, the software 63 will proceed with the purchase. The License Provider component 50 will deduct the correct value from the User's token accounts, using multiple tokens when necessary, and issue a product license.

In one embodiment, the User's software 63 allows the User the option of merging two or more tokens to combine their value. In another embodiment, the License Provider automatically applies as many tokens are necessary and available when the value of the purchase exceeds the value of one token.

A User can move their tokens from one computer to another through a restoration process. This restoration process can also be used to reestablish tokens that are lost due to computer malfunction.

The token is protected against theft by its connection to and association with the User's computer and the User ID.

User tokens and gift certificates have the following properties:

A gift certificate purchased through web interface is not tied to the purchaser, so it can be given to another person as a gift and spent by the recipient.

A purchaser of a gift certificate through the web interface must enter recipient's name and specify an email address of the recipient, and optionally, a short message. The certificate is sent by email to the specified recipient.

The purchaser of a gift certificate must specify a password at the time of purchase. The purchaser then must privately communicate the password to the recipient. The recipient is not allowed to install the gift certificate without knowing the password.

A gift certificate is tied to the recipient customer's User ID after it has been installed and used to make a purchase. This reduces the chances of unauthorized use of tokens or gift certificates. Customers will not lose their tokens to thieves.

A token purchased via specialized software 63 is tied to the purchaser's User ID. Only the customer who purchased the token and people authorized by the purchaser (i.e. those having access to the computer of the purchaser and knowing the password) can spend it.

The User does not have to keep track of their Token Ids because they are stored in the computer's registry.

There is no way to use the Tokens except from the User's computer, so they cannot be stolen, except by stealing the User's computer. Additional safeguards such as passwords can protect against use of the Tokens on a stolen computer.

Specialized software 63 can handle multiple certificates on a User's machine. For example, a User may buy a token, and receive several Gift Certificates from others. This User must be able to use all of these certificates. Software 63 automatically uses multiple tokens when available on the User's computer if the remaining value in a single token is not enough to cover the cost of a product being purchased.

Communication of personal data such as credit card information and name and address of the purchaser between the License Provider and User or the web browser client is securely encrypted.

The use of tokens offers advantage over having separate credit card transactions for each purchase, however, because a token can be purchased for, say $100, and then the User can make ten distinct purchases, each for $10, and can avoid the delay of receiving credit approval for each transaction. Further, the User's credit card statement will show one large transaction rather than ten small ones.

Playing a Product (Step 26)

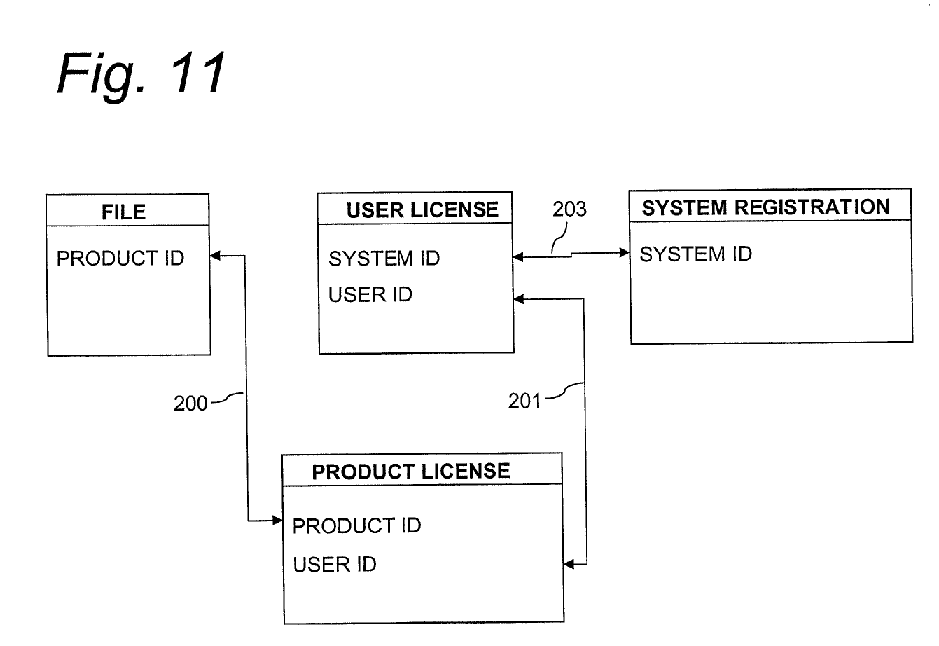

A User 6 accesses specialized software 63 on his/her computer to play a licensed Product. This specialized software 63 evaluates whether a User is authorized to view and play the full contents of a Product (130). A Product License is tied to the User's User License, since it contains the User ID. As illustrated in FIG. 11, each time a Product 10 is played, the information in the Product License is checked against information in the User License to make sure they match (200). Specifically, the specialized software 63 reviews the Product ID in the Product file and searches for a Product License bearing the same Product ID. The software 63 then compares the User ID on the Product License to the User ID in the User License stored in the computer's registry (201). The software 63 also checks the System ID in the User License to confirm that it matches the System ID in the computer registry (203).

The Product file remains encrypted until the moment it plays, and always reverts to preview mode if transferred to another computer.

In a preferred embodiment, the following protocols are used to control Product licenses and minimize opportunity for someone to distribute licensed material to unauthorized users, while at the same time allowing Users the flexibility to move licenses from one computer to another and to distribute Products 10 that can then be licensed to other Users:

Upon an initial successful purchase of a Product license, a User License is created in the User's name. This User License is saved in the User's registry in encrypted form and contains the System ID of the User 6 as well as the user's personal information, in particular credit card information. The personal information is locked by the user's password. Any purchased Product license is linked to the User 6 by means of a reference to the User ID.

Transferring Product Licenses to another machine without also transferring the User License will render the Product Licenses invalid.

Users are warned against giving their User License to another person because it contains the User's credit card information. This is a big disincentive for a User 6 to give away his or her User License.

In order to transfer licenses from one machine to another (licensed Users are allowed to do this), one has to use specialized software 63 to back up one's User License from one machine to a floppy disk and then restore it, using Specialized software 63 again, on the other machine. Specialized software 63 can then retrieve all Product Licenses that the User 6 owns from License Provider's server.

In order for a User 6 to perform the above procedure, the User 6 must enter their password. Specialized software 63 will not restore licenses if the correct password is not entered.

The License Provider server keeps track of the number of times license restoration is attempted by a User. A limit is placed on how many times one can restore licenses from the server. For some Users 6 whose User Licenses contain no credit card information, a low limit is placed, such as three or four. After four successful acts of restoration of licenses, the User 6 who attempts the fifth will be asked to enter a valid credit card number. The License Provider server must validate the card number before granting the fifth restoration. So Users will be discouraged from giving away their User Licenses not because of exposure of their credit card information but because they may lose their ability to restore their licenses (they will be loudly warned of this consequence).

For Users whose User Licenses do contain credit card information a limit is also placed on the number of restorations allowed. This limit however is much higher, preferably ten restorations per year.

Registry data that was exported without the involvement of specialized software 63 is invalidated. To achieve this, an ID of the machine (such as the Windows registration name, hard disk ID, or user's login name) can be used, as illustrated in FIG. 11. Specifically, every time a User License is saved to registry, the User's system ID is also saved. The ID is bundled with the User License and encrypted, so the User License exported from registry without involvement of Specialized software 63 is invalid. Each time a licensed Product is being played, the specialized software 63 checks the system ID on the machine and make sure it matches the one saved with User License. This will not create any trouble for Users. If a user's operating system crashed, the unfortunate User would have to restore the licenses anyway, using specialized software 63 which would get the new system ID and save it with the User License.

Accounting and Payment to Vendor (Step 27)

The Payment Authority 53 stores data regarding each transaction in the Database 51 (150). When a token or gift certificate is used for payment, the Payment Authority 53 records a credit to the Vendor of the Product purchased by the User with the token or gift certificate. The License Provider preferably sorts transactions by Vendor periodically to determine and make lump sum payments due to Vendor for their licenses for the period. The transaction information can be mined to give Vendors useful sales data.

Security

Public/private key encryption and symmetric encryption algorithms are used for encrypting sensitive data involved in communication between the Vendor and the License Provider and between the User and the License Provider.

Although an illustrative version of the system and method is shown, it should be clear that many modifications to the system and method may be made without departing from the scope of the invention. Data transmissions described herein can be made by any technology known or yet to be invented that allows the movement of data from one computer device to another. This includes, but is not limited to the use of a hard-wired connections and wireless connections.

What is claimed is:

1. A digital token, comprising:
a) a token identifier stored on a user's computer; and
b) a user identifier stored on the user's computer in association with said token identifier.

2. A digital token according to claim 1, further comprising:
c) a vendor identifier.

3. A digital token according to claim 1, further comprising:
c) a balance representing the monetary value of the token.

4. A method of distributing a digital token, comprising the steps of:
a) receiving a data transmission comprising a credit card number, a monetary amount and a unique previously-assigned user identifier;
b) assigning a unique token identifier and storing said token identifier in association with said user identifier and said amount; and
c) transmitting to the user who is associated with said identifier a digital token including the token identifier and the user identifier.

5. A method of distributing a digital token according to claim 4, further comprising the steps of:
c) storing a password in association with the token identifier.

6. A method of obtaining a digital token comprising the steps of:
a) purchasing a digital token from a token distributor;
b) receiving a digital transmission from the distributor including said token; and
c) installing said token on a computer registry.

7. A method according to claim 6, wherein said token includes a token identifier.

8. A method according to claim 7, wherein said token includes a user identifier.

9. A method according to claim 7, wherein said token includes the monetary balance that is available to be spent that is represented by the token.

10. A method of charging payment against a previously purchased digital token, comprising the steps of:
a) receiving via data connection a data transmission requesting application of a token balance toward payment for a purchase, said data transmission including a token identifier and a user identifier; and
b) subtracting the purchase price from the token balance and storing the updated token balance in association with the token identifier.

11. A method of charging payment against a previously purchase digital token according to claim 10, further comprising the step of:
c) transmitting via data connection to the user the updated token balance.

12. A method of digitally distributing a digital license in exchange for payment via a digital token, comprising the steps of:
a) providing a server computer networked for data transmission with multiple users, said server running software for dispensing digital licenses and software for dispensing digital tokens and said server housing a database;
b) assigning to a user a user identifier and storing the user identifer in said database;
c) making a digital license available for purchase;
d) transmitting a digital token to a user, said token including a token identifier;
e) storing in said database said token identifier in association with the user identifier and a monetary value for the token;
f) receiving a request via data transmission from a user to purchase a digital license, said user request including a user identifier and a token identifier
g) upon request received via data transmission from a user to purchase a digital license, applying the value of the token against the purchase price of the product;
h) subtracting the purchase price from the token value and storing the updated token balance in said database;
i) transmitting the license to the user.

13. A method according to claim 12, further comprising the steps of:
j) upon receipt of a user request to purchase a digital license with a previously purchased digital token, comparing the user identifier and the token identifer in the request with data stored in the database to determine whether the token identifier is stored in association with the same user identifier.

14. A method according to claim 12, further comprising the step of:
j) upon receipt of a user request to purchase a digital license with a previously purchased digital token, comparing the balance stored in the database in association with the token identifier to determine whether the token represents a value at least as great as the purchase price of the digital license requested.

15. A digital token system, comprising:
a) a server computer running software for dispensing digital tokens, said server being connected to multiple user computers for data transmission therebetween;
b) data storage housing a database connected with said software, said database including token records, each token record including a token identifier and a user identifier.

16. A method for purchasing a digital token, comprising the steps of:
a) receiving via data transmission to a computing device a user identifier;
b) storing said user identifier on said computing device;
c) sending a data transmission requesting a digital token, said request including the user identifier and a monetary value for the token;
d) receiving via data transmission a digital token, said token including a token identifier and said user identifier; and
e) storing said token on said computing device.

17. A method of making a purchase via a previously purchased digital token having a token identifier and representing an original monetary value, comprising the steps of:
a) from a computer on which is stored a previously-purchased digital token containing a token identifier and on which is stored a previously-assigned user identifier, transmitting a request to make a purchase, said request including said token identifier and said user identifier and a monetary amount for the purchase; and
b) receiving via data transmission an updated monetary value represented by the token having been lessened by the purchase amount.
